(19) United States
(12) Patent Application Publication
(10) Pub. No.: US 2006/0263490 A1
(43) Pub. Date: Nov. 23, 2006

(54) Frozen confectionery maker

(76) Inventors: Eric Wall, Auburn, AL (US); Ka Lok Joe Liu, Kowloon (CN)

Correspondence Address: JACKSON WALKER L.L.P., Suite 2100, 112 E. Pecan Street, San Antonio, TX, 78205, US

(21) Appl. No.: 11/134,833

(22) Filed: May 19, 2005

(51) Int. Cl. A23G 9/00

(52) U.S. Cl. 426/101

(57) ABSTRACT

A frozen confectionary maker has a cup holder on a housing for removably receiving a cup with a cavity in its wall and base for receiving freezable solution. The cup holder has a rotateable coupling for rotateably engaging the cup. A motor in the housing rotates the coupling and cup. A removable stirrer is fixedly positioned with the housing above the cup holder for stirring a confectionary mixture in the cup when the cup rotates.

### BACKGROUND TO THE INVENTION

1. Field of the Invention

The invention relates to frozen confectionery makers, and in particular to soft-serve ice-cream makers.

2. Background Information

Frozen confectionery makers have been known since 1846 when the hand cranked freezer was invented by a woman named Nancy Johnson. An example of a modern frozen confectionery maker is found in U.S. Pat. No. 4,736,600. This patent describes a motor driven self-dispensing frozen confectionery maker. The device comprises a closed mixing bowl pivotally mounted on a cradle. A paddle/auger assembly is provided for mixing the confectionery mixture. The confectionery mixture is mixed within the bowl and when ready to serve the bowl rotates, or tilts, within the cradle and the paddle/auger assembly reverses to dispense the frozen confectionery through a dispensing aperture.

Another modern frozen confectionary maker is described in Assignees U.S. Pat. No. 6,622,511, the contents of which are incorporated herein by reference. U.S. Pat. No. 6,622,511 describes a frozen confectionery maker having a container with a cavity in its walls and base for receiving freezable solution. There is a lid for closing the container and a mixer rotateably engageable with the lid to locate within the container. A drive means receivable on the lid rotates the mixer. A dispensing passage has a valve with a first position that returns frozen confectionery to the container during mixing and second position for dispensing the confectionery to a serving dish or cup.

Disadvantages with the above apparatus include that they both make a large quantity of frozen confectionery in one operation and that they both include dispensing arrangements which can be messy and difficult to clean.

### SUMMARY OF THE INVENTION

It is an object of the present invention to overcome or ameliorate the above disadvantages or at least to provide the public with a useful alternative.

According to the invention there is provided a frozen confectionary maker comprising a housing, a cup having a cavity in a wall and base for receiving freezable solution, a cup holder provided on the housing for removably receiving the cup and having a rotateable coupling for rotateably engaging the cup, a motor located within the housing for rotating the coupling, and a removable stirrer fixedly positioned with the housing above the cup holder for stirring a confectionary mixture in the cup as the cup is rotated by the rotateable coupling.

Preferably, the cup wall and stirrer have corresponding shapes, and the stirrer is off-set within the cup for moving around the wall as the cup is rotated.

Preferably, the stirrer is a spoon for stirring and serving frozen confectionary.

Preferably, the stirrer includes an opening for allowing confectionary mixture to pass through the stirrer.

Preferably, the stirrer further includes a blade across the opening for separating confectionary mixture passing through the stirrer.

Preferably, the coupling comprises a turntable and a coaxial coupling peg protruding from the turntable.

Preferably, the housing includes a removable top having a lid for closing the cup and an opening for fixedly positioning the removable stirrer.

Further aspects of the invention will become apparent from the following description, which is given by way of example only.

### BRIEF DESCRIPTION OF THE DRAWINGS

Embodiments of the invention will now be described by way of example only and with reference to the accompanying drawings in which:

FIG. 1 is a perspective view of a frozen confectionary maker according to the invention,

FIG. 2 is an internal view of the base of the confectionery maker,

FIG. 3 is a second internal view of the base of the confectionery maker,

FIG. 4 is a stirrer/serving spoon of the confectionery maker, and

FIG. 5 is a sectional view through the preparation/serving cup of the confectionery maker.

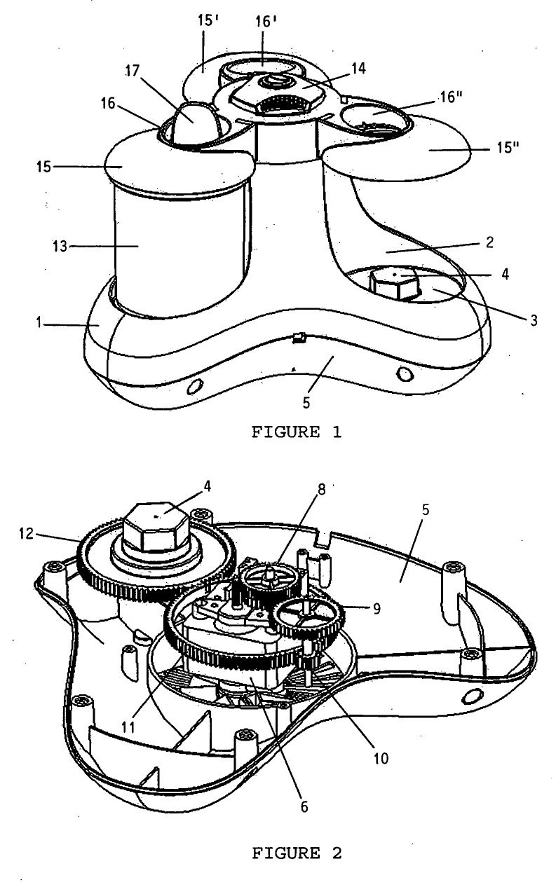

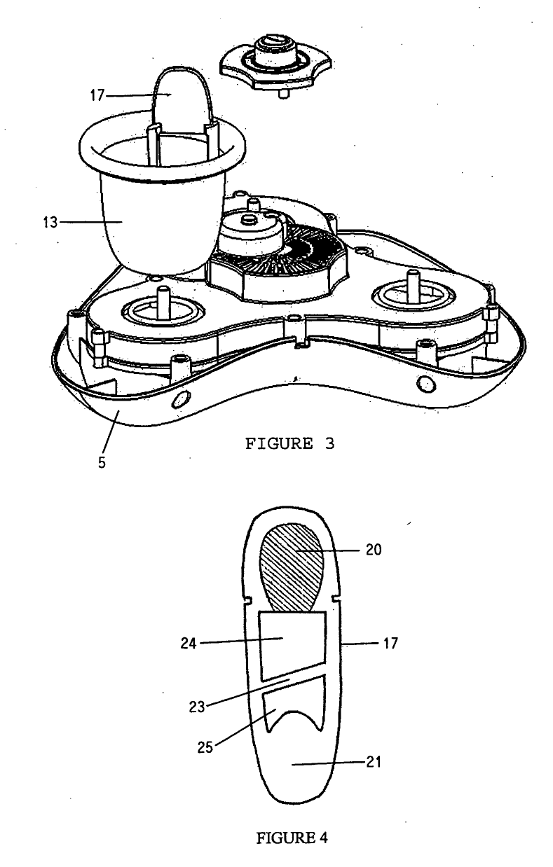

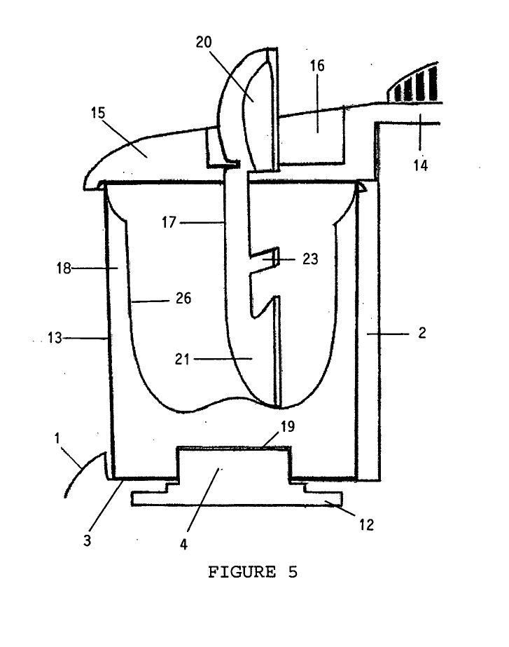

### DESCRIPTION OF THE PREFERRED EMBODIMENTS

The invention will now be described with reference to a soft-serve ice-cream maker, however the invention can be used for other frozen confectionery makers.

In the drawings there is depicted an ice-cream maker comprising a housing 1 with three locations for producing three separate single servings of ice-cream (or other frozen confectionary). The three locations are spaced 120 degrees apart about, and extend radially from, a central axis of the ice-cream maker. Each location comprises a cup holder 2 having a flat rotateable turntable 3 with a hexagonal peg 4 positioned coaxially with the turntable 3. Only one preparation location is shown in detail in the drawings for clarity. All locations are identical.

Mounted within based 5 of the ice-cream maker is a motor 6 within a motor housing 7. The motor 6 drives a plurality of spindle mounted gears 8, 9, 10 to rotate a gear ring 11. Each hexagonal coupling peg 4 is provided with a drive gear 12 engaged with the ring gear 11. Operation of the motor 6 drives the hexagonal couplings 4 and turntables 3.

A preparation and serving cup 13 is removably provided in the cup holder 2 of each serving location. Each serving cup 13 has a cavity 18 within its walls and base for receiving a freezeable cooling solution. The cups 13 also have a hexagonal recess 19 in their base for positioning on and rotateably engaging with hexagonal pegs 4 of platforms 3. During operation of the motor 6 the cups 13 are caused to rotate within the cup holders 2.

A removable top 14 is positioned on housing 1 and has three limbs each with a lid 15 which in use is positioned over and closes the cups 13 located within cup holders 2. The limbs of the top 14 each have an opening 16 in the lids 15. The openings 16 support three removable stirring and serving spoons 17 which are held fixedly in place within respective cups 13. As the cups 13 are rotated within the cup holders 2 the stirrers/spoons 17 mix freezeable ice-cream mixture within the cups 13.

The stirrers/spoons 17 each comprise two parallel limbs with a handle 20 at one end and a flat thin spatula 21 at its opposite end. The flat thin spatula 21 functions as a paddle during preparation of ice-cream and as a scoop for picking up ice-cream for eating. A narrow blade 23 extends between the two parallel limbs defining two openings 24, 25. The internal walls 26 of the cups 13 have a profile corresponding the spatula end 21 of the stirrers/spoons 17. The stirrers/spoons 17 are off-set within the cups 13 to move around the internal walls 26 as the cups 13 rotate. The ice-cream, or other frozen confectionary, mixture is scooped from the walls 26 and forced through the openings 24, 25 in the stirrers/spoons 17. Blade 23 separates and aerates the mixture as it passes through the stirrers/spoons 17.

After preparation of ice-cream the lid 14 is removed leaving the stirring and serving spoons 17 in place within the cups 13. The cups 13 and spoons 17 can be removed from the cup holders 2 ready for eating directly from the cups 13 using the spoons 17.

A frozen confectionery maker according to the invention can prepare three small servings of frozen confectionery at one time. The three servings are eaten directly from the preparation cups 13 using the stirring spoons 17. The freezeable solution for the cup wall cavities, frozen confectionery ingredients and preparation time are well-known in the art and so need not be described in detail. Details are given in Assignees U.S. Pat. No. 6,622,511.

Where in the foregoing description reference has been made to integers or elements have known equivalents then such are included as if individually set forth herein.

Embodiments of the invention have been described, however it is understood that variations, improvements and/or modifications can take place without departing from the scope of the appended claims.

What is claimed is:

1. A frozen confectionary maker comprising:
a housing,
a cup having a cavity in a wall and base for receiving freezable solution,
a cup holder provided on the housing for removably receiving the cup and having a rotateable coupling for rotateably engaging the cup,
a motor located within the housing for rotating the coupling, and
a removable stirrer fixedly positioned with the housing above the cup holder for stirring a confectionary mixture in the cup as the cup is rotated by the rotateable coupling.

2. The confectionary maker of claim 1 wherein the cup wall and stirrer have corresponding shapes, and the stirrer is off-set within the cup for moving around the wall as the cup is rotated.

3. The confectionary maker of claim 1 wherein the stirrer is a spoon for stirring and serving frozen confectionary.

4. The confectionary maker of claim 1 wherein the stirrer includes an opening for allowing confectionary mixture to pass through the stirrer.

5. The confectionary maker of claim 4 wherein the stirrer further includes a blade across the opening for separating confectionary mixture passing through the stirrer.

6. The confectionary maker of claim 1 wherein the coupling comprises a turntable and a coaxial coupling peg protruding from the turntable.

7. The confectionary maker of claim 1 wherein the housing includes a removable top having a lid for closing the cup and an opening for fixedly positioning the removable stirrer.

8. A frozen confectionary maker comprising:
a housing,
at least two cups having a cavity in a wall and base for receiving freezable solution,
at least two cup holders provided on the housing for receiving the cups and having rotateable couplings for rotateably engaging the cups,
a motor located within the housing for rotating the couplings, and
at least two removable spoons fixedly positioned with the housing above respective cup holders for stirring a confectionary in the cups as the cups are rotated.
